(19) United States
(12) Patent Application Publication
(10) Pub. No.: US 2025/0107539 A1
(43) Pub. Date: Apr. 3, 2025

(54) Co-Extruded Dough Product with High-Particulate Filling

(71) Applicant: General Mills, Inc., Minneapolis, MN (US)

(72) Inventors: Katherine Davis, Minneapolis, MN (US); Patrick Kenney, Minneapolis, MN (US); Matthew C. Larsen, Champlin, MN (US); Hannah Marie Schmit, Eden Prairie, MN (US)

(73) Assignee: General Mills, Inc., Minneapolis, MN (US)

(21) Appl. No.: 18/374,963

(22) Filed: Sep. 29, 2023

(51) Int. Cl. A21D 13/37; A21C 11/16; A21D 13/31; A21D 13/38

(52) U.S. Cl. CPC A21D 13/37; A21C 11/163; A21D 13/31; A21D 13/38

(57) ABSTRACT

A co-extruded filled dough product comprises a dough shell casing and a filling material co-extruded with the dough shell casing. The filling material includes greater than about 40% of a particulate component and less than about 60% of a sauce component. The sauce component has a Bostwick consistency greater than about 7 cm and can be, e.g., a cheese-based sauce or a tomato-based sauce. A method of producing a filled dough product comprises co-extruding a dough shell casing and a filling material. A system for producing a filled dough product comprises a dough shell casing extruder die for forming a dough shell casing and a filling material die configured to extrude a filling material within the dough shell casing.

### FIELD OF THE INVENTION

The invention generally pertains to food products and, more particularly, to dough products with fillings that have particulates.

### BACKGROUND OF THE INVENTION

Frozen snack foods are well known in the food industry and are a convenience enjoyed by many consumers. One example of a frozen snack food is a filled dough product that is often pre-cooked then frozen and sold to consumers for later reheating. Pizza rolls are a popular type of filled dough product and typically have a filling that contains a sauce and particulates (e.g., meat pieces, cheese pieces, veggies, etc.). Manufacturers of pizza rolls and similar filled dough products are challenged with ensuring particulates maintain piece integrity during processing and are included in amounts sufficient for consumers to recognize all the components of the filling.

### SUMMARY OF THE INVENTION

A co-extruded filled dough product of the present invention comprises a dough shell casing and a filling material co-extruded with the dough shell casing. The filling material includes greater than about 40% of a particulate component and less than about 60% of a sauce component. The particulate component can include meat (e.g., bacon, sausage, chorizo etc.), egg or egg substitute (e.g., plant-based egg alternative), vegetables (e.g., potato), cheese or imitation cheese (e.g., imitation cheddar cheese) or combinations thereof. The sauce component has a Bostwick consistency greater than about 7 cm and can be, e.g., a cheese-based sauce or a tomato-based sauce. In some embodiments, the sauce component includes starch in an amount configured to give the sauce component a Bostwick consistency greater than 7 cm. In some embodiments, the filling material has a dynamic viscosity of over about 1000 cP (centipoise) at a temperature between about 30° F. and about 40° F.

A method of producing a filled dough product in accordance with the present invention comprises co-extruding a dough shell casing and a filling material. The filling material includes greater than about 40% of a particulate component and less than about 60% of a sauce component. The sauce component has a Bostwick consistency greater than 7 cm. In some embodiments, the filling material has a dynamic viscosity of over about 1000 cP at a temperature between about 30° F. and about 40° F.

A system for producing a filled dough product in accordance with the present invention comprises a dough shell casing extruder die for forming a dough shell casing and a filling material die configured to extrude a filling material within the dough shell casing, where the filling material includes about 40% to about 45% of a particulate component and about 55% to about 60% of a sauce component, the sauce component having a Bostwick consistency greater than 7 cm.

### BRIEF DESCRIPTION OF THE DRAWINGS

FIG. 1 is a flow chart of a method used to produce a filled dough product in accordance with the present invention.

FIG. 2 is a schematic view of a system used to produce a filled dough product in accordance with the present invention.

### DETAILED DESCRIPTION OF EMBODIMENTS

Initially, it should be noted that the embodiments of the present invention described below are not intended to be exhaustive or limit the invention to the precise forms disclosed in the following detailed description. Rather, a purpose of the embodiments chosen and described is so that the appreciation and understanding by others skilled in the art of the principles and practices of the present invention can be facilitated.

Throughout the present description, unless otherwise specified, the concentrations expressed as percentages always refer to the weight/weight (w/w) percentage, i.e., grams of a given component per 100 g of composition, i.e., wt % or percent by weight. The term “about” refers to a deviation of up to plus/minus 10%, preferably plus/minus 5%.

Typically, the filling in pizza rolls contains about 60-65% sauce and about 35-40% particulates (e.g., meat pieces, cheese pieces, veggies, etc.) Depending on the sauce and particulates employed, other filled dough products may require more particulates in the filling to ensure the consumer can recognize the components of the filling. However, an increase in the amount of particulates in the filling means less sauce is available to carry the particulates as needed during the manufacturing process. For example, in a process employing a multi-lane filler fed by a single pump, the particulates take the path of least resistance such that the particulates are more likely to concentrate in the inner lanes (straight from the pump) while the sauce is more likely to go to the outer lanes. This undesirably results in dough filled with either too much sauce or too much particulate. The present inventors were faced with producing a filled dough product containing a filling having more than about 40% (e.g., about 45%) particulates (i.e., having a “high-particulate” content). The present inventors have discovered that adjusting the viscosity and/or consistency of a high-particulate filling and/or a sauce portion thereof ensures the sauce carries the high-particulate content evenly to each of the filling lanes of a multi-lane filler driven by a single pump while maintaining a consistent ratio of sauce to particulates across all of the lanes. On the other hand, achieving a particular viscosity and/or consistency only for the purposes of consumer enjoyment can result in some snacks having too much sauce and some snacks with too much particulate content when the filling has a high particulate content.

A co-extruded filled dough product of the present invention comprises a dough shell casing and a filling material co-extruded with the dough shell casing. The filling material includes greater than about 40% (e.g., about 40% to about 45%; about 45%) of a particulate component and less than about 60% (e.g., about 55% to about 60%; about 55%) of a sauce component.

The particulate component can include meat (e.g., bacon, sausage, chorizo etc.), egg or egg substitute (e.g., plant-based egg alternative), vegetables (e.g., potato), cheese or imitation cheese (e.g., imitation cheddar cheese) or combinations thereof. In some embodiments, particulates in the particulate component have an average size of about ⅛ cubic inch or greater (e.g., ¼ cubic inch).

The sauce component (separate from the particulate component) has a Bostwick consistency greater than about 7 cm (e.g., about 8 cm or from about 7 cm to about 8 cm). The Bostwick consistency of the sauce component is measured using a Bostwick consistometer before the sauce component is combined with the particulate component, at a temperature of 70-100 degrees Fahrenheit. The sauce component can be, e.g., a cheese-based sauce or a tomato-based sauce. In some embodiments, the sauce component includes a spice blend (e.g., salt, pepper, cheese powder, etc.) In some embodiments, the sauce component includes starch (e.g., in an amount configured to give the sauce component a Bostwick consistency greater than 7 cm).

In some embodiments, the filling material has a dynamic viscosity of over about 1000 cP (centipoise) at a temperature between about 30° F. and about 40° F. In preferred embodiments, the filling material has a dynamic viscosity between about 2000 cP and about 3000 cP at a temperature of between about 30° F. and about 40° F. The dynamic viscosity of the filling material can be measured in-line or off-line. For example, dynamic viscosity can be directly measured in-line with an in-line viscometer between a filling hold tank and the extruders.

In some embodiments, the co-extruded filled dough product comprises about 52.5% dough shell casing and about 47.5% filling material.

In some embodiments, the co-extruded filled dough product is a breakfast-type product including a cheese-based sauce as its sauce component and cooked egg/egg substitute, potato, cheese/imitation cheese and/or meat in its particulate component.

A method of producing a filled dough product in accordance with the present invention comprises co-extruding a dough shell casing and a filling material. The filling material includes greater than about 40% (e.g., about 40% to about 45%; about 45%) of a particulate component and less than about 60% (e.g., about 55% to about 60%; about 55%) of a sauce component. The sauce component has a Bostwick consistency greater than 7 cm. In some embodiments, the filling material has a dynamic viscosity of over 1000 cP at a temperature between about 30° F. and about 40° F.

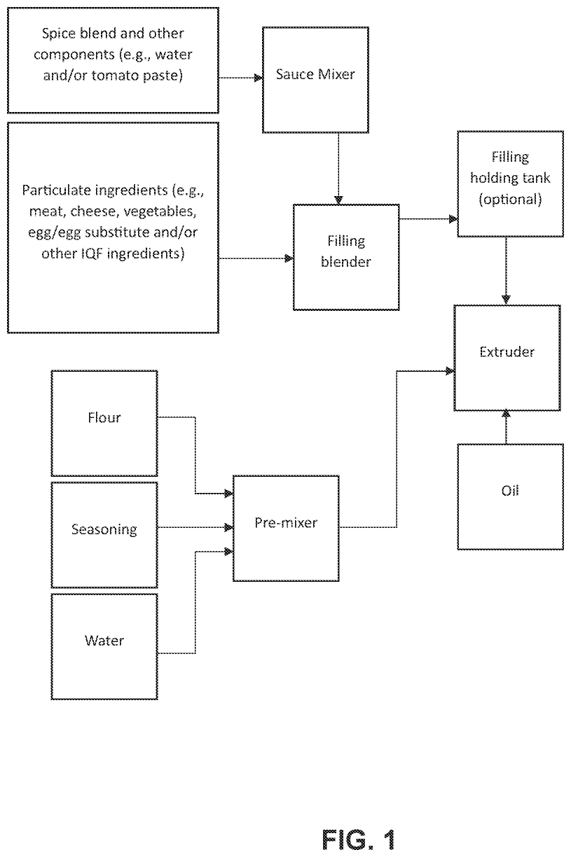

In some embodiments, the method of producing a filled dough product further includes combining the particulate component with the sauce component to form the filling material. See, e.g., in FIG. 1 how a sauce component and a particulate component are combined in a filling blender. In some embodiments, the sauce component is prepared by mixing a spice blend and other components (e.g., water and/or tomato paste). In some embodiments, the filling material is pumped from a holding tank to an extruder. The dough shell casing can be formed by combining flour, seasoning and water (e.g., hot water). See, e.g., flour, seasoning and water combined in a pre-mixer as shown in FIG. 1. Oil can be sent to the extrude alongside the dough shell casing material and filing material.

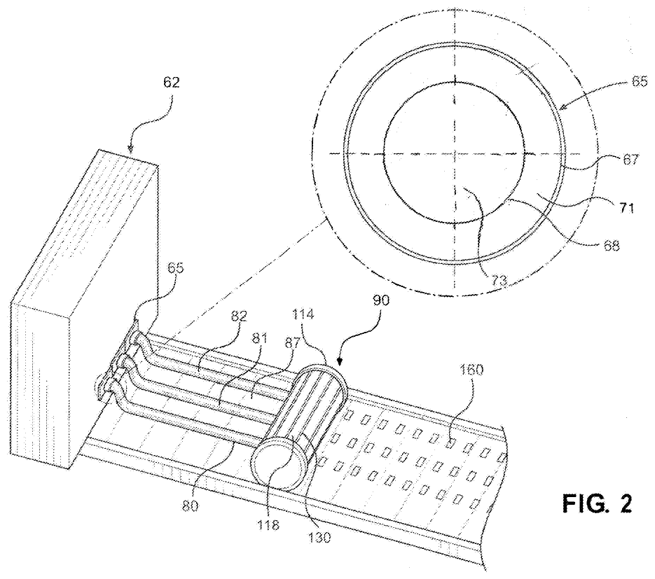

A system for producing a filled dough product in accordance with the present invention comprises a dough shell casing extruder die for forming a dough shell casing and a filling material die configured to co-extrude a filling material within the dough shell casing, where the filling material includes about 40% to about 45% of a particulate component and about 55% to about 60% of a sauce component, with the sauce component having a Bostwick consistency greater than 7 cm. Reference is made to FIG. 2 in describing an exemplary system employed to make filled dough products, with this exemplary arrangement being presented for purposes of fully understanding the invention. As shown, the arrangement of FIG. 2 employs a multi-row extruder 62 having a plurality of laterally spaced heads, one of which is indicated at 65. As shown in the enlarged view, each head 65 includes an outer channel defining member 67 and a concentric, inner channel defining member 68 establishing an outer die port 71 and a central die port 73. Flowing through outer die port 71 is an outer dough shell casing material, while a co-extruded filling material in accordance with the invention as detailed above simultaneously flows through central die port 73. In the manufacturing scenario depicted, extruder 62 forms a plurality of elongated, laterally spaced rows of food product which are deposited, in the form of continuous ropes 80-82, onto a common conveyor 87.

Downstream extruder 62 is provided a combination crimping and cutting assembly which is generally indicated at 90 extending across conveyor 87. In the exemplary embodiment disclosed, combination crimping and cutting assembly 90 includes a roller 114 having an outer surface 118 from which project a plurality of laterally extending and circumferentially spaced crimping and cutting members, one of which is indicated at 130. As ropes 80-82 are directed beneath crimping and cutting assembly 90, individual filled dough products 160 are continuously produced through a pinching and severing operation, with each product 160 including an outer dough shell casing which encapsulates the inner filling material. At this point, it should be noted that the above-described production stages could be performed manually but, more preferably, are part of a mass production process. Certainly, if mass produced, even more than three product lines could be established using conveyor 87.

### EXAMPLES

Two different filling materials, “Bacon Scramble” and “Sausage Scramble”, were prepared using the ingredients and amounts detailed in Table 1A below. Diced potato, plant-based egg alternative, bacon/sausage and imitation cheddar made up the particulate components. The diced potato is IQF (individual quick frozen) and about ¼ inch in size. Table 1B shows the ingredients and amounts for the sauce components.

First, the sauce component was prepared by adding water to a high shear mixer then adding the spice blend while the mixer ran at low speed. The mixer was then run at high speed for about two minutes before a Bostwick consistency measurement was taken. See the “Sauce Bostwick Consistency” column in Table 2 below.

Next, the sauce component was pumped over to a filling blender (low speed, horizontal ribbon blender) and the particulate component ingredients (meat, cheese, potato, plant-based egg alternative) were conveyed into the filling blender as the blender ran at a low speed. The blender continued to run for about two minutes after all the particulate component ingredients were added to form the filling material.

The prepared filling material was pumped to a filling hold tank that also has a horizontal ribbon agitating at a low speed. The filling material was pumped from the hold tank to a waterwheel. The waterwheel is where the filling was directed from one stream into eight streams. A rotating cylinder has eight indents across its length that are the target volume of filling for a single filled dough product. The filling exits the waterwheel into eight different streams that are then pumped a short distance through the die heads of each extruder. An in-line viscometer to measure dynamic viscosity is located between the hold tank and the waterwheel. See the “Filling Viscosity” column in Table 2.

At each extruder, dough is co-extruded around the outside of the filling to make a contained “rope” of product. The rope was formed and cut by a set of two rollers that both crimp and cut the product into individual filled dough products. Individual filled dough products were then conveyed onto a shaker table where the vibration causes them to separate along the width of a belt to create space between the products as they enter the fryer. Regular quality checks were performed on individual filled dough products prior to entering the fryer to ensure correct filling distributions. Sample products were collected and manually opened to weigh components separately and ensure correct component usages.

TABLE 1A

| | Bacon | Sausage |
|---|---|---|
| | Scramble | Scramble |
| Filling Ingredient | Formula % | Formula % |
| 1/4″ IQF diced potato | 9.00% | 9.00% |
| Plant-based egg alternative | 13.00% | 13.00% |
| Bacon | 13.00% | 0.00% |
| Sausage | 0.00% | 13.00% |
| Diced Imitation Cheddar Cheese | 10.00% | 10.00% |
| Sauce | 55.00% | 55.00% |
| Total | 100.00% | 100.00% |

TABLE 1B

| | Bacon | Sausage |
|---|---|---|
| | Scramble | Scramble |
| Sauce Ingredient | Formula % | Formula % |
| Water | 84.95% | 84.95% |
| Spice Blend (including about | 15.05% | 15.05% |
| 35% starch and about 7% | | |
| methylcellulose on a weight basis) | | |
| Total | 100.00% | 100.00% |

TABLE 2

| | | Filling | Filling |
|---|---|---|---|
| | Sauce Bostwick | Temperature | Viscosity |
| Batch | Consistency (cm) | (° F.) | (cP) |
| Bacon Scramble #1 | 8.0 | 36 | 2700 |
| Bacon Scramble #2 | 8.1 | 37 | 2100 |
| Sausage Scramble #1 | 8.0 | 31 | 2200 |
| Sausage Scramble #2 | 8.0 | 35 | 2200 |

1. A co-extruded filled dough product comprising
a dough shell casing; and
a filling material co-extruded with the dough shell casing, the filling material including:
about 40% to about 45% of a particulate component; and
about 55% to about 60% of a sauce component, the sauce component having a Bostwick consistency greater than 7 cm.

2. The dough product of claim 1, wherein the filling material has a dynamic viscosity of over about 1000 cP at a temperature between about 30° F. and about 40° F.

3. The dough product of claim 2, wherein the filling material has a dynamic viscosity between about 2000 cP and about 3000 cP at a temperature of between about 30° F. and about 40° F.

4. The dough product of claim 1, wherein the particulate component includes egg or egg substitute.

5. The dough product of claim 1, wherein the sauce component includes starch in an amount configured to give the sauce component the Bostwick consistency greater than 7 cm.

6. A method of producing a filled dough product, the method comprising
co-extruding a dough shell casing and a filling material, where the filling material includes
about 40% to about 45% of a particulate component and
about 55% to about 60% of a sauce component, the sauce component having a Bostwick consistency greater than 7 cm.

7. The method of claim 6, wherein the filling material has a dynamic viscosity of over about 1000 cP at a temperature between about 30° F. and about 40° F.

8. The method of claim 7, wherein the filling material has a dynamic viscosity between about 2000 cP and about 3000 cP at a temperature of between about 30° F. and about 40° F.

9. The method of claim 6, wherein the particulate component includes egg or egg substitute.

10. The method of claim 6, wherein the sauce component includes starch in an amount configured to give the sauce component the Bostwick consistency greater than 7 cm.

11. A filled dough product produced by the method of claim 6.

12. A system for producing a filled dough product, the system comprising
a dough shell casing extruder die for forming a dough shell casing; and
a filling material die configured to extrude a filling material within the dough shell casing, the filling material including:
about 40% to about 45% of a particulate component; and
about 55% to about 60% of a sauce component, the sauce component having a Bostwick consistency greater than 7 cm.
